(19) United States
(12) Patent Application Publication
(10) Pub. No.: US 2010/0330304 A1
(43) Pub. Date: Dec. 30, 2010

(54) SECURITY LAMINATES WITH A SECURITY FEATURE DETECTABLE BY TOUCH

(75) Inventors: Ingrid Geuens, Emblem (BE); Carlo Uyttendaele, Mortsel (BE)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: AGFA-GEVAERT NV, Mortsel (BE)

(21) Appl. No.: 12/918,012

(22) PCT Filed: Apr. 1, 2009
(86) PCT No.: PCT/EP09/53905

§ 371 Date: Aug. 17, 2010

Related U.S. Application Data
(60) Provisional application No. 61/041,483, filed on Apr. 1, 2008.

(30) Foreign Application Priority Data
Apr. 1, 2008 (EP) 08103283.1

(51) Int. Cl. B32B 27/36; B32B 3/24; B42D 15/10; B32B 38/04; B32B 37/00

(52) U.S. Cl. 428/29; 428/138; 264/400; 156/272.8

(57) ABSTRACT

A security laminate precursor comprising a plurality of lamellae and layers, wherein at least one of the outermost lamellae is an axially stretched linear polyester film and the security laminate precursor comprises a touch-detectable relief structure on a side of the security laminate precursor having as outermost lamella the axially stretched linear polyester film, the relief structure being associated with a viewable non-surface image which is a pattern made up of micro-perforations. A security laminate and a process for preparing a security laminate are also disclosed.

### TECHNICAL FIELD

This invention relates to security laminates with a security feature detectable by touch.

### BACKGROUND ART

The term “security laminate” encompasses tamper proof seals on medications, video cassettes, compact discs, and packaging; security features on labels and tags; and identification documents, which includes documents; magnetic disks; cards involved in the electronic transfer of money such as bank cards, cheque cards, pay cards, credit cards and debit cards; phone cards; stored value cards; prepaid cards; shopping cards; loyalty cards; smart cards (e.g., cards that include one more semiconductor chips, such as memory devices, microprocessors, and microcontrollers); contact cards; contact less cards; proximity cards (e.g., radio frequency (RFID) cards); passports; driving licenses; network access cards; employee badges; security cards; visas; immigration documentation; national ID cards; citizenship cards; social security cards and badges; medical care cards; certificates; identification cards or documents; voter registration and/or identification cards; police ID cards, border crossing cards; security clearance badges and cards authorizing access to the bearer of the card to particular areas such as a company (employee ID card), the military and a public service; gun permits; badges; gift certificates or cards; membership cards or badges of clubs and societies; tags; CD's; consumer products; knobs; keyboards; electronic components, etc., or any other suitable items or articles that may record information, images, and/or other data, which may be associated with a function and/or an object or other entity to be identified.

Five features am particularly important when producing and using security laminates. First, once applied to an article it is important that the laminate is difficult to remove to ensure that the underlying item is not altered or subjected to tampering. Second, a desirable laminate is difficult if not impossible to duplicate by counterfeiters. Third, if tampering occurs it is important to quickly and accurately recognize an altered or counterfeit laminate. Fourth, it is important that manufacturing costs of the laminates are not prohibitively expensive. Fifth, when used on articles such as identification cards, it is important that the laminate has sufficient durability to withstand harsh treatment.

There are usually two types of “printing” on security laminates. The first type of printing involves a “background” printing made up of reference and security information. The reference information may include, for example, the issuing agency, as we as other numerical data. The security information may be in the form of a watermark, an encoded magnetic strip, numerical sequences, a holographic image, etc. The second type of printing is made up of “personalized” information, such as a photographic, fingerprint, signature, name, address, etc.

U.S. Pat. No. 4,508,916 (ORELL FUESSLI) discloses a multi-layer identification card comprising a card layer for carrying at least part of the information the card provides on one surface of the card layer; a transparent, protective plastic film covering all of the one surface of the card layer; an adhesive layer securing the card layer one surface to the protective plastic film; the adhesive strength of the adhesive layer being greater than the tensile strength of the protective plastic film, whereby the film is irreversibly destroyed if removed from the card layer; steel gravure printing formed on the exterior surface of the protective plastic film prior to engagement of the film with the card one layer; the printing being highly visible and readily sensed by touch for verification purposes; the original relief present in the steel gravure printing of the transparent sheet being substantially unchanged in the identification card after the transparent film covering is secured to the card layer one surface.

U.S. Pat. No. 4,544,181 (GAO) discloses a multilayer identification card, comprising two cover sheets at least one of which is transparent and an opaque card core laminated between the cover sheets and provided with visually perceptible information defined by patterns, letters, numbers and/or pictures, the improvement comprising the presence of the information in the card core in the form of localized, visible, thermally and irreversibly degraded core portions formed in the core by means of a laser beam traversing the transparent cover sheet subsequent to core lamination to the cover sheet, whereby the information is also formed in the cover sheet in register with and simultaneously with the information in the card core, wherein the information on the transparent cover sheet is preferably in relief and can be sensed by touch.

U.S. Pat. No. 5,314,739 (NACIONAL MONEDA TIMBRE) discloses an improvement in security paper having opposite surfaces for bank notes and other documents embedded with security yarns that can be microprinted or have fluorescent or iridescent characteristics, the improvement wherein the yarns make up groups, of at least three in number, with the yarns in each group braided together to form a braid having a thickness in excess of one hundred microns and extending above a surface of the paper and allowing the easy detection thereof using the sense of touch.

GB 2132136 A (METAL BOX) discloses a method of preparing an identity card by using a scanning laser engraver which damages and discolours the plastics to form images so that the images form an integral part of the structure of the card and are also closely associated with the printed security patterns. GB 2132136 A (METAL BOX) does not disclose a viewable non-surface image made by perforation of the identity card.

WO 03/055638 A (DIGIMARC) discloses a method of producing a security feature in an identification document, wherein a pattern is laser etched into the top surface of the identification document. However, WO 03/055638 A (DIGIMARC) also does not disclose a viewable non-surface image made by perforation of the identity card.

The prior art is silent in respect of touch-detectable relief structure associated with a viewable non-surface image in security laminates. There is therefore a need for a touch-detectable relief structure associated with a viewable non-surface image.

### DISCLOSURE OF INVENTION

It is therefore an aspect of the present invention to provide a security laminate with a security feature detectable by touch associated with a viewable non-surface image.

Further aspects of the present invention will become apparent from the description hereinafter.

### SUMMARY OF THE INVENTION

Surprisingly it had been found that a touch-detectable relief structure associated with a viewable non-surface image can be realized during micro-perforation of security laminates when a side of the security laminate with a linear polyester film as the outermost lamella is subject to CO₂ laser irradiation, CO₂ laser micro-perforation of polycarbonate-cards results in slight yellow coloration on the side and no touch-detectable relief structure is produced. CO₂ laser micro-perforation cannot be used for PVC-cards due to the occurrence of poisonous and corrosive gases in addition to a brown coloration at the edges of the areas in which perforation is performed.

Aspects of the present invention are realized by a security laminate as defined by claim 1.

Aspects of the present invention are also realized by a process for preparing a security laminate comprising the steps of:

a) providing a security laminate precursor comprising a plurality of lamellae and layers, wherein at least one of the outermost lamellae of the security laminate is an axially stretched linear polyester film; and

b) irradiating the side of the security laminate precursor with the linear polyester film as outermost lamella with a laser to provide an image by microperforation thereby producing a touch detectable relief structure associated with a viewable non-surface image which is the pattern made up of microperforations.

Aspects of the present invention are also realized by use of at least one component in microperforations of a security laminate precursor or a security laminate to provide a security feature, wherein the at least one component is selected from the group consisting of luminescent dyes, phosphorescent dyes, fluorescent dyes, luminescent pigments, phosphorescent pigments, fluorescent pigments, infrared dyes, infrared pigments and magnetic particles.

### DETAILED DESCRIPTION OF THE INVENTION

### Definitions

The term “security laminate precursor”, as used in disclosing the present invention, means an intermediate product used in the realization of security laminates.

The term “touch-detectable”, as used in disclosing the present invention, means that detection is possible by humans touching with their fingers.

The term “lamella”, as used in disclosing the present invention, means a self-supporting thin polymeric sheet optionally provided with an adhesive system used in producing laminates using pressure optionally together with heat. A “layer” is considered not to be self-supporting and requires a lamella or film as a support. The term “lamellae” includes films and prelaminates.

The term “viewable image”, as used in disclosing the present invention, means an image which can be viewed immediately or by holding the security laminate up to a light source.

The term “micro-perforation”, as used in disclosing the present invention, means a perforation having a size less than 300 μm in diameter.

The term “film”, as used in disclosing the present invention, means a self-supporting polymer-based sheet, which may be associated with adhesion layers e.g. subbing layers.

The term “pattern made up of micro-perforation”, as used in disclosing the present invention, means any pattern made up of micro-perforations which can be produced reproducibly.

The term “non-surface image”, means an image not confined to the surface i.e. in the bulk of the security laminate or security laminate precursor.

PET is an abbreviation for polyethylene terephthalate.

PET-C is an abbreviation for biaxially stretched polyethylene terephthalate.

PETG is an abbreviation for polyethylene terephthalate glycol, the glycol indicating glycol modifiers i.e. partial replacement of ethylene glycol by alternative glycols such as 1,4-cyclohexane-dimethanol or neopentyl glycol which minimize brittleness and premature aging that occur if unmodified amorphous polyethylene terephthalate (APET) is used in the production of cards.

### Security Laminate Precursors

Aspects of the present invention are realized by a security laminate precursor comprising a plurality of lamellae and layers, wherein at least one of the outermost lamellae of the security laminate is a linear polyester film and the security laminate comprises a touch-detectable relief structure on a side of the security laminate having as outermost lamella the linear polyester film, the relief structure being associated with a viewable image.

The viewable image is a pattern made up of micro-perforations, preferably produced with a laser.

The linear polyester film is preferably axially stretched, more preferably biaxially stretched.

According to a preferred embodiment of the security laminate precursor, according to the present invention, the security laminate precursor comprises a layer comprising an optionally micro-perforated DTR image.

According to a preferred embodiment of the security laminate precursor, according to the present invention, the security laminate precursor further comprises at least one lamella selected from the group consisting of amorphous polyester lamellae, polycarbonate lamellae, polyolefin lamellae and polyvinyl chloride lamellae.

The security laminate precursor can be used to produce a security laminate, which may optionally be fully micro-perforated, but in security laminates comprising a chip for contact less operation and/or an antenna to boost the signal from the chip optionally itself containing an antenna this could adversely affect the functioning of the chip and/or antenna.

### Security Laminates

A security laminate according to the present invention comprises a plurality of lamellae and layers, wherein at least one of the outermost lamellae of the security laminate is a linear polyester film and the security laminate comprises a touch-detectable relief structure on a side of the security laminate having as outermost lamella the linear polyester film, the relief structure being associated with a viewable non-surface image.

The viewable image is a pattern made up of micro-perforations, preferably produced with a laser.

The linear polyester film is preferably axially stretched, more preferably biaxially stretched.

According to a preferred embodiment of the security laminate, according to the present invention, the security laminate comprises a layer comprising an optionally micro-perforated DTR image.

According to a preferred embodiment of the security laminate, according to the present invention, the security laminate further comprises at least one lamella selected from the group consisting of amorphous polyester lamellae, polycarbonate lamellae, polyolefin lamellae and polyvinyl chloride lamellae.

The security laminate according to the present invention is preferably an identity document.

The security laminate according to the present invention is preferably an identification (identity) card.

The security laminates of the present invention are readily suited to making a direct pre-cut card with improved physical properties. The ID card stock of the invention provides improved flexural durability over an extended period of time vs. PVC, while retaining good stiffness and impact strength.

Pre-cut ID card stock can be easily produced by conventional methods using the above-described composite film structure in the conventional shape, size, e.g., 54.5 mm×86 mm, and having a thickness of about 0.8 mm. A pre-cut and stock is one which is made to the card size specifications before printing and exits the printer system without any further trimming or cutting required. An overcoat laminate may be applied after printing if desired.

The thickness of both the polymeric core substrate and oriented polymeric film is variable, but the overall thickness is usually in the range of 685 to 838 μm, thus about 760 μm±80 μm. The outer surfaces of the ID card stock can be printed with dye images or text. Optionally, non-varying information, such as lines, line segments, dots, letters, characters, logos, guilloches, etc., can be printed on the polymeric core substrate by non thermal dye transfer methods such as flexo or offset printing before attaching the polymeric core substrate to the oriented polymeric film or films carrying the external dye-receiving layer or layers.

The composite ID card stock of the invention can also be readily milled for placement of a memory chip. Alternatively, the polymeric core substrate and an oriented polymeric film can be pre-punched before attaching to provide a suitable site for a memory chip or in the case of contact less applications the chip can be interlaminated.

The security laminate according to the present invention is preferably comprises a security laminate precursor as described above wherein the outermost lamellae are not perforated biaxially stretched polyethylene terephthalate films having a thickness of at least 10 μm, more preferably a thickness of at least 20 μm. By laminating the security laminate precursor after microperforation, the security laminate becomes more robust as no perforations are torn into each other. The touch-detectable relief structure is no longer detectable. By “closing” the microperforations on both sides of the security laminate with a protective laminate or biaxially stretched polyethylene terephthalate films no dust particles can penetrate into the microperforation and hence they cannot disturb the viewable non-surface image formed by the microperforations.

The unperforated protective laminates or biaxially stretched polyethylene terephthalate films also make falsification more difficult since additional microperforations cause directly visible and touch-detectable perforations. Laminating a second protective laminate or biaxially stretched polyethylene terephthalate film on the newly perforated security laminate makes it not only noticeably thicker, but also makes the original microperforations no longer touch-detectable.

### Process

Aspects of the present invention are realized by a process comprising the steps of: providing a security laminate comprising a plurality of lamellae and layers, wherein at least one of the outermost lamellae of the security laminate is a linear polyester film; and irradiating a side of the security laminate with a linear polyester film as outermost lamella with a laser to provide an image by micro-perforation thereby producing a touch detectable relief structure on the surface of the irradiated polyester film.

According to a first embodiment of the process, according to the present invention, the laser is an infrared laser.

According to a second embodiment of the process, according to the present invention, the laser is selected from the group consisting of a Nd:YAG laser and a CO₂-laser.

Suitable lasers include the high-power CO₂-lasers from ROFIN and the CO₂-laser used in a CardMasterOne™ from Industrial Automation Integrators b.v.

The microperforations can also be made by drilling, but are preferably using a laser since this provides for a higher accuracy and the diameter of the microperforations can be varied more easily.

### Biaxially Oriented Polyester Lamella

The thickness of the oriented polymeric lamella employed in the present invention can be between 12 μm and 250 μm. Any orientable polyester can be used in the security laminates, adhesion s and processes, according to the present invention.

In a preferred embodiment of the invention, a linear polyester is employed. Such a material is well known to those skilled in the art and is obtained by condensing one or more dicarboxylic acids or their lower (up to 6 carbon atoms) diesters, e.g., terephthalic acid, isophthalic acid, phthalic acid, 2,5-, 2,6- or 2,7-naphthalenedicarboxylic acid, succinic acid, sebacic acid, adipic acid, azelaic acid, 4,4′-diphenyldicarboxylic acid, hexahydroterephthalic acid or 2-bis-p-carboxyphenoxyethane (optionally with a monocarboxylic acid, such as pivalic acid), the corresponding dicarboxylic acid dialkyl ester or lower alkyl ester with one or more glycols, e.g., ethylene glycol, 1,3-propanediol, 1,4-butanediol, neopentyl glycol and 1,4-cyclohexanedimethanol. In a preferred embodiment, the polyester polymer is obtained by condensing terephthalic acid or 2,6-naphthalenedicarboxylic acid or their dimethyl esters with ethylene glycol. In another preferred embodiment, the polymer is PET. The PET film prepared from the above-described composition must be oriented. In a preferred embodiment, the PET film is biaxially-oriented. Such a process is described in many patents, such as GB 838,708, the disclosure of which is hereby incorporated by reference. These techniques are well known to those skilled in the art.

According to a ninth embodiment of the security laminate, according to the present invention, the polyester is an orientable polyester with polyesters comprising monomer units selected from the group consisting of terephthalate units, isophthalate units, naphthalate units, ethylene units, neopentylene units, 1,4-cyclohexane dimetliylene units and —CH₂CH₂OCH₂CH₂— units being preferred e.g. polyethylene terephthalate (PET), polyethylene naphthalate (PEN).

### DTR

Photographic diffusion transfer processes have been known for several years and are summarized e.g. in imaging Systems by Kurt I. Jacobson and Ralph E. Jacobson (1977) The Focal Press.

Furthermore, it has also in extenso been described for security applications in Chapter 17 of “Identification Security Systems Based on Silver Diffusion Transfer Imaging” by L. L. Vermeulen in Optical Document Security. Edited by VAN RENESSE Rudolf L. Norwood, Mass.: ARTECH HOUSE, INC., 1994. ISBN 0890066191.

In a black-and-white DTR-process (Diffusion Transfer Reversal process), also called silver diffusion transfer, a silver salt complex is image-wise transferred by diffusion from an image-wise exposed silver halide emulsion layer to an image-receiving material wherein, with the aid of a developing agent and promoted by electroless deposition catalysts, i.e. so-called development nuclei, the silver salt complexes are reduced to silver in a pattern opposite the exposing image.

In dye diffusion transfer processes, an image-dye-providing substance is associated with a silver halide emulsion. An image-dye-providing substance, which provides a positive transferred image in an image-receiving material as a function of development of a conventional negative silver halide emulsion, is referred to as positive-working. Likewise, an image-dye-providing substance which provides a negative transferred image in an image-receiving layer as a function of development of a conventional negative silver halide emulsion, is referred to as negative working.

Dye-diffusion systems operating with photosensitive silver halide can be carried out in a number of ways, but they are all based on the same principle, i.e. the alteration in the mobility of a dye or dye-forming structural moiety of a compound controlled by the image-wise reduction of silver compounds to silver.

The coating of the dye diffusion transfer image receptor layer on the support proceeds preferably with slide hopper coater or curtain coater known to those skilled in the art.

The polymeric mordant in the diffusion transfer image receptor layer is chosen depending upon the dye to be mordanted. If acid dyes are to be mordanted, the receptor layer can be composed of or contain basic polymeric mordants such as polymers of amino-guanidine derivatives of vinyl methyl ketone such as described in U.S. Pat. No. 2,882,156 (KODAK), and basic polymeric mordants and derivatives, e.g. poly-4-vinylpyridine, the 2-vinylpyridine polymer metho-p-toluene sulphonate and similar compounds described in U.S. Pat. No. 2,484,430 (KODAK), and polymeric mordants described in U.S. Pat. No. 4,266,044 (AGFA).

Suitable polymeric mordants also include e.g. guanylhydrazone derivatives of acyl styrene polymers, as described by U.S. Pat. No. 3,740,228 (AGFA).

Effective polymeric mordants include long-chain quaternary ammonium or phosphonium compounds or ternary sulphonium compounds, e.g. those described in U.S. Pat. No. 3,271,147 (KODAK) and cetyltrimethyl-ammonium bromide. Certain metal salts and their hydroxides that form sparingly soluble compounds with the acid dyes may be used too. The dye mordants may be dispersed in a hydrophilic binder in the dye diffusion transfer image receptor layer, e.g. in gelatin, polyvinylpyrrolidone or partly or completely hydrolysed cellulose esters.

Other suitable cationic polymeric mordants for fixing anionic dyes are disclosed in U.S. Pat. No. 4,186,014 (AGFA).

In the preferred embodiment, the polymeric mordant is a basic compound and the dyes are anionic dyes. Suitable anionic dyes include e.g. sulphinic acid salt dyes that are image-wise released by a redox-reaction described as described in EP 004399 A (AGFA) and U.S. Pat. No. 4,232,107 (AGFA).

Other suitable dyes are those disclosed in U.S. Pat. No. 5,037,731 (AGFA), U.S. Pat. No. 4,855,223 (AGFA), U.S. Pat. No. 4,777,124 (AGFA) and U.S. Pat. No. 4,605,613 (AGFA) incorporated herein as a specific reference for the dyes.

Generally, good results are obtained when the dye diffusion transfer image receptor layer, which is preferably permeable to alkaline solution, is transparent and about 4 μm to about 10 μm thick. This thickness, of course, can be modified depending upon the result desired. The dye diffusion transfer image receptor layer may also contain ultraviolet absorbing materials to protect the mordanted dye images from fading, brightening agents such as the stilbenes, coumarins, triazines, oxazoles, dye stabilizers such as the chromanols, alkyl-phenols, etc.

### INDUSTRIAL APPLICATION

The security laminates and adhesion systems, according to the present invention, can be used in identity documents such as driver's licenses, ID-cards and passports, and on other important documents such as certificates of title. Security laminates are also useful as tamper proof seals on medications, video cassettes, and compact discs.

### EXAMPLES

The invention is illustrated hereinafter by way of COMPARATIVE EXAMPLES and INVENTION EXAMPLES. The percentages and ratios given in these examples are by weight unless otherwise indicated.

### Materials

All materials used in the following examples were readily available from standard sources such as Aldrich Chemical Co. (Belgium) and Acres (Belgium) unless otherwise specified. The water used was deionized water.

MEK is methyl ethyl ketone.

KIESELSOL™ 100 F is a 36% aqueous dispersion of colloidal silica from BAYER.

MERSOLAT™ H is an alkyl sulphonate surfactant from BAYER.

Arkopal™ NO60 is a nonyl-phenyl-oxy-polyethylene-glycol (EO 6) from AVECIA.

Arkopon™ T8015 is a sodium salt of N-methyl-N-2-sulfoethyl-oleylamide from AVECIA, supplied as a 40% concentrate.

Hostapon™ is the sodium salt of N-methyl-N-oleoyltaurate manufactured by HOECHST.

Dymax is a solvent free polyurethane adhesive Dymax™ 2072 from DYMAX Corp.

Delo is a UV— and light curing acrylate adhesive available under the tradename Delo-Photobond™ 4436 from DELO industrial Adhesives.

Platilon™ ID5051 is a 30 g/m² hot melt polyurethane film from EPUREX.

Scapa™ G160 is a 20 μm hot melt polyurethane film from the SCAPA Group Pic.

### Example 1

Aqueous compositions were prepared for coating subbing layer and 2 and adhesion layers 1 and 2 having according to Table 1 to

TABLE 1

| Composition subbing layer 1 (dry coating thickness ca. | |
|---|---|
| 0.19 μm) | mg/m² |
| copolymer of vinylidene chloride, methyl acrylate and | 151 |
| itaconic acid 88:10:2 by weight | |
| colloidal silica (KIESELSOL ™ 100F) | 35 |
| Mersolat ™ H | 0.75 |

TABLE 2

| Composition subbing layer 2 (dry coating thickness ca. | |
|---|---|
| 0.17 μm) | mg/m² |
| copolymer of vinylidene chloride, methyl acrylate and | 147.3 |
| itaconic acid 88:10:2 by weight | |
| poly(3,4-ethylenedioxythiophene)/PSS | 2.58 |
| colloidal silica (KIESELSOL ™ 100F) | 16.4 |
| Mersolat ™ H | 0.74 |

TABLE 3

| Composition adhesion layer 1 (dry coating thickness ca. | |
|---|---|
| 0.73 μm) | mg/m² |
| Gelatin [mg/m²] | 380 |
| colloidal silica (KIESELSOL ™ 100F) | 340.7 |
| Arkopon ™ T8015 | 3.33 |
| Arkopal ™ N060 | 6.67 |
| 1 μm diameter polymethylmethacrylate particles | 0.04 |

TABLE 4

| Composition adhesion layer 2 (dry coating thickness ca. | |
|---|---|
| 0.73 μm) | mg/m² |
| Gelatin [mg/m²] | 380 |
| colloidal silica (KIESELSOL ™ 100F) | 340.8 |
| Arkopon ™ T8015 | 3.3 |
| Arkopal ™ N060 | 6.7 |
| 3 μm diameter polymethylmethacrylate particles | 1.7 |

### Lamination of 35 μm PETG-Film to 63 μm PET-C:

A 63 μm PET-C film was provided on one side with subbing layer 1 at a coating weight of 187 mg/m² and an adhesion layer 1 at a coating weight of 7301 mg/m² on top of the subbing layer 1.

The other side of the 63 μm PET-C film was provided with subbing layer 2 at a coating weight of 167 mg/m² and an adhesion layer 2 at a coating weight of 732.5 mg/m² on top of the subbing layer 2.

After drying the adhesion layer 2, a layer of Liofol™ UK 3640 with Liofol™ hardener 6800 both from HENKEL was coated from a methylethylketone solution on top of the adhesion layer 2.

A PETG-film was then laminated thereon using a roll laminator at room temperature.

### Laminate Precursor (Prelam-I):

A 63 μm PET-C film provided with subbing layer 1 on one side and subbing layer 2 (antistatic, layer) on the other side was coated on one side with a sequence of layers consisting of a gelatinous layer, a gelatinous DTR-receiving layer and a protective layer. A DTR image was applied to the gelatinous DTR-receiving layer using an ANAIS system of AGFA. The resulting in a laminate precursor having the following configuration:

Prelam-I

protective layer
gelatinous DTR-receiving layer containing a DTR-image
gelatinous layer
subbing layer 1
63 μm PET-C
polyurethane-adhesive

### Laminate Precursor II (Prelam-II):

A 500 μm opaque PETS film was sandwiched between two 35 μm opaque PETG films and laminated with an Oasys™ OLA6/7 Desktop Plate Laminator. The Oasys™ OLA6/7 Desktop Plate Laminator was set at lamination temperature of 160° C. and a pressure setting of 40.

Prelam-II

35 μm opaque PETG
500 μm opaque PETG
35 μm opaque PETG

### Laminate Precursor III (Prelam-III):

A 63 μm PET-C film provided with subbing layer 1 on one side and subbing layer 2 (antistatic layer) on the other side was coated on one side with a sequence of layers consisting of a gelatinous layer and a protective layer resulting in the following configuration:

Prelam-III

35 μm PETG
polyurethane-adhesive
subbing layer 2
63 μm PET-C
subbing layer 1
gelatinous layer
protective layer

### Protective Laminate

A 23 μm unsubbed PET-C film was coated with Liofol™UK 3840 with Liofol™hardener 6800 available from HENKEL.

A 30 μm PE film was laminated to the 23 μm PET-C film resulting in a protective 30 μm PE/23 μm PET-C laminate.

### Identity Card ID-I

An identity card ID-I with an ID-1 format as defined in ISO 7810 was produced by laminating together precursor laminates I, II and III and then laminating the protective laminate to both sides of the resulting laminate to provide a card comprising a DTR-image in laminate I with the following configuration:

Identity card ID-I

Protective laminate
Prelam-I
Prelam-II
Prelam-III
Protective laminate

### Identity Card ID-II

A self-laminated identity card ID-II with an ID-1 format as defined in ISO 7810 was produced with the following configuration:

Identity card ID-II

63 μm PET-C
35 μm PETG
100 μm transparent PEC ™ Type 2800
opaque 200 μm PETG
opaque 200 μm PETG
100 μm transparent PEC ™ Type 2800
35 μm PETG
63 μm PET-C
PEC ™ Type 2800 is a symmetrical coextrudate supplied by FOLIENWERK WOLFEN GMBH in which a core of polycarbonate is sandwiched between PETG-films; and the opaque 200 μm PETG with 6% by weight titanium dioxide was also supplied by FOLIENWERK WOLFEN GMBH.

### Identity Card ID-III

A self-laminated identity card ID-III with an ID-1 format as defined in ISO 7810 was produced with the following configuration:

Identity card ID-III

63 μm PET-C
35 μm PETG
120 μm opaque PEC ™ Type 64611
opaque 200 μm PETG
opaque 200 μm PETG
120 μm opaque PEC ™ Type 64611
35 μm PETG
63 μm PET-C
PEC ™ Type 64611 is a symmetrical coextrudate supplied by FOLIENWERK WOLFEN GMBH in which a core of polycarbonate is sandwiched between PETG-films; and the opaque 200 μm PETG with 6% by weight titanium dioxide was also supplied by FOLIENWERK WOLFEN GMBH.

### Identity Card ID-IV

A self-laminated polycarbonate identity card ID-IV with an ID-1 format as defined in ISO 7810 was produced with the following configuration:

Identity card ID-IV

125 μm transparent Makrofol ™ DE 1-1 (non-laser writable)
50 μm transparent Makrofol ™ DE 1-4 (laser writable)
250 μm opaque Makrofol ™
250 μm opaque Makrofol ™
50 μm transparent Makrofol ™ DE 1-4 (laser writable)
125 μm transparent Makrofol ™ DE 1-1 (non-laser writable)
Makrofol ™ are polycarbonate films available from BAYER.

### Microperforation

Micro-perforation was carried out using the CO₂-laser in a CardMasterOne from Industrial Automation Integrators B.V. on the identity cards ID-I to ID-IV at the same position in all the cards. The effect on the image colour of micro-perforation of the DTR-image comprised in the ID-I card and the effect of micro-perforation on the colour of the ID-IV card was monitored using measurements with an X-rite densitometer in reflection with visible, cyan, magenta and yellow filters respectively. The results are summarized in Table 5. D₁, D₂ and D₃ were obtained from the colour measurements in order of increasing magnitude of optical density and the numerical colour value (NCV) given in Table 5 was obtained using the expression given below:

$$N C V = \frac{{D}_{1} \times {D}_{2}}{{( {D}_{3} )}^{2}}$$

The larger the NCV value the better the colour neutrality of the obtained image. Maximal colour neutrality corresponds with a NCV value of 1.

TABLE 5

| | | Colour measurements | | | | |
|---|---|---|---|---|---|---|
| | | | cyan | magenta | yellow | |
| | | visible | filter | filter | filter | |
| Card | Perforated | filter | D₁ | D₂ | D₃ | NCV |
| ID-IV | No | 0.09 | 0.09 | 0.09 | 0.10 | 0.81 |
| | Yes | 0.16 | 0.15 | 0.17 | 0.23 | 0.48 |
| ID-I | No | 0.13 | 0.13 | 0.13 | 0.15 | 0.75 |
| | Yes | 0.20 | 0.19 | 0.20 | 0.23 | 0.72 |

These measurements show that in the case of ID-I the NCV-value was not significantly affected by the micro-perforation process, whereas in the case of the polycarbonate-card the NCV-value was significantly affected by the micro-perforation process.

The effect of the removal of the card material upon the mechanical strength of the cards was tested by bending the card 90°. This resulted in fracture of the polycarbonate card ID-IV if bent to 90° in a perforated area, whereas in the case of ID-I to ID-III no fracture was observed even if the bend corresponded to a perforated area.

The effect of the micro-perforation process on the surface of the cards was also investigated. In the case of cards ID-I to ID-III, a touch-detectable relief was established on the side of the card from which the micro-perforation was performed, whereas in the case of the polycarbonate card ID-IV no touch-detectable relief was established on the side of the card from which micro-perforation was performed. This effect was quantified using stylus profilometry with a DEKTAK 8 Stylus Profiler from VEECO INSTRUMENTS INC. with a 2.5 μm stylus tip with an angle at the tip of 45° and the results are given in Table 6.

TABLE 6

| | ID-I | ID-II | ID-III | ID-IV |
|---|---|---|---|---|
| micro-perforation | yes | yes | yes | yes |
| with a CO₂ laser | | | | |
| strength after | no fracture | no fracture | no fracture | fracture |
| micro-perforation | upon | upon | upon | upon |
| | bending | bending | bending | bending |
| touch-detectable | yes | yes | yes | no |
| profile on irradiated | | | | |
| side | | | | |
| relief height on | 10-20 | 10-20 | 10-20 | ≦5 |
| irradiated side [μm] | | | | |
| discoloration on | no | no | no | yellow |
| irradiated side | | | | coloration |

The results in Table 6 confirm that the relief obtained with the ID-I to ID-III cards is considerably greater than that with the ID-IV, the 100% polycarbonate card.

The micro-perforation was in the form of an image and hence a touch-detectable relief structure was observed with a security laminate with as outermost lamella a linear polyester film, this relief structure being associated with a viewable non-surface image.

### Example 2

This example illustrates the advantage of laminating the protective laminate after microperforation.

### Preparation and Testing of ID Cards

Two samples of identity card ID-I were prepared in the same way as in EXAMPLE 1.

On both samples 13 microperforations were drilled in a straight line with a drill of 0.2 mm at a distance of 2 mm from each other. The obtained microperforations had a diameter of 150 μm (measured with a Dino microscope, 200×).

Two samples of identity cards ID-V were prepared in exactly the same manner as the identity card ID-I with the exception that the protective laminates were laminated after the 13 microperforations were performed.

The identity cards were subjected to two tests:

1. A dynamic bending test in the direction of the length of the card according to ISO10373-1-5-8 (100,000 times bonded).

2. A folding test with a Elcometer™ 1500 mandrel having a diameter of 2 mm, wherein the backside of the identity card is folded once over the mandrel and with the straight line of 13 microperforations parallel with the axis of the 2 mm-mandrel. The results of the two tests are given in Table 7.

TABLE 7

| | | | Number of torn perforations | |
|---|---|---|---|---|
| | | | Elcometer 1x | Dynamic |
| Lamination of | | | folding test over | bending |
| Protective laminate | Identity Card | | 2 mm mandrel | 100,000x |
| Before perforation | ID-I | Sample 1 | 9 of 13 | 0 of 13 |
| | | Sample 2 | 12 of 13 | 0 of 13 |
| After perforation | ID-V | Sample 1 | 0 of 13 | 0 of 13 |
| | | Sample 2 | 0 of 13 | 0 of 13 |

From Table 7, it is clear that by laminating the protective laminates after the microperforation, the identity card becomes more robust as no perforations were torn into each other. The touch-detectable relief structure is no longer detectable.

By “closing” the microperforations on both sides of the identity card with the protective laminate no dust particles can penetrate into the microperforation and hence they cannot disturb the viewable non-surface image formed by the microperforations.

The unperforated protective laminate also makes falsification more difficult since additional microperforations cause directly visible and touch detectable perforations of the protective laminate. Laminating a second protective laminate on the perforated protective laminate makes the identity card noticeably thicker.

### Example 3

This example illustrates the effect of the type and the thickness of the protective laminate or biaxially stretched polyethylene terephthalate film laminated after microperforation.

### Preparation of Security Laminate Precursor SLP-1

A security laminate precursor SLP-1 in an ID-1 format as defined in ISO 7810 was produced by laminating together the precursor laminates I, II and III of EXAMPLE 1 in that order using a Oasys™ OLO6/7 desktop plate laminator. The Oasys™ OLO6/7 desktop plate laminator was set at a lamination temperature of 160° C., a distance of 1 mm between the rolls and a pressure setting of 40.

### Preparation of Protective Laminate and PET-C Films

### Preparation of the 23 μm PET-C/Amcor

A 23 μm unsubbed PET-C film was coated with Liofol™UK 3640 with Liofol™hardener 6800 available from HENKEL.

### Preparation of the 63 μm PET-C/SUB-3

A 63 μm PET-C film was provided on one side with subbing layer 3 according to Table 8 at a coating weight of 591 mg/m².

TABLE 8

| Composition subbing layer 3 | mg/m² |
|---|---|
| copolymer of vinylidene chloride, methyl acrylate and itaconic | 467 |
| acid 88:10:2 by weight | |
| colloidal silica (KIESELSOL ™ 100F) | 121 |
| Mersolat ™ H | 0.9 |
| Sodium hydroxide | 1.8 |

### Preparation of the 100 μm PET-C/SUB-4

A 100 μm PET-C film was provided on one side with subbing layer 4 according to Table 9 at a coating weight of 591 mg/m².

TABLE 9

| Composition subbing layer 4 | mg/m² |
|---|---|
| copolymer of terephthalic acid, isopththalic acid, 5- | 188 |
| sulfoisopththalic acid sodium salt and ethyleneglycol | |
| 17.8:12.5:0.9:68:8 by weight | |
| colloidal silica (KIESELSOL ™ 100F) | 47 |
| Hostapon ™ T | 0.9 |

### Lamination and Evaluation of Outermost Lamellae

In the security laminate precursor SLP-1, 13 microperforations were drilled in a straight line with a drill of 0.2 mm at a distance of 2 mm from each other. The obtained visible microperforations had a diameter of 150 μm (measured with a Dino microscope, 200×). The perforated security laminate precursors were then laminated on both sides with a protective laminate or with a biaxially stretched polyethylene terephthalate film as shown by Table 10 using a GMP Excellam™ 655Q hot roll laminator. The GMP Excellam™ 655Q hot roll laminator was set at a lamination temperature of 160° C., a distance of 1 mm between the rolls, a speed setting of 1 and inserting the laminates protected between a silicon based paper (Codor-carrier N° 57001310 from CODOR) to prevent sticking to laminator rolls.

The same folding test as in EXAMPLE 2 with an Elcometer™ 1500 mandrel having a diameter of 2 mm was used these security laminates.

TABLE 10

| Protective laminate | Relief touch | Number of torn |
|---|---|---|
| or PET-C film | detectable? | perforations |
| None | Yes | 13 |
| 6 μm PET-C | No | 10 |
| 70 μm PVC | No | PVC |
| | | delaminates |
| 63 μm PET-C/SUB-3/Dymax/30 μm PE | No | 0 |
| 63 μm PET-C/SUB-3/Delo/30 μm PE | No | 0 |
| 63 μm PET-C/SUB-3/30 μm PE | No | 0 |
| 100 μm PET-C/SUB-4/Dymax/30 μm PE | No | 0 |
| 100 μm PET-C/SUB-4/Delo/30 μm PE | No | 0 |
| 100 μm PET-C/SUB-4/30 μm PE | No | 0 |
| 23 μm PET-C/Amcor/Platilon ID5051 | No | 0 |
| 63 μm PET-C/SUB-3/Platilon ID5051 | No | 0 |
| 100 μm PET-C/SUB-4/Platilon ID5051 | No | 0 |
| 23 μm PET-C/Amcor/Scapa G160 | No | 0 |
| 63 μm PET-C/SUB-3/Scapa G160 | No | 0 |
| 100 μm PET-C/SUB-4/Scapa G160 | No | 0 |

From Table 10, it should be clear that a PET-C film of 6 μm is riot sufficient to prevent torn perforations. The 70 μm PVC film delaminated when folding the security laminate over the 2 mm mandrel. The PET-C laminates with a thickness of 23 μm to 100 μm all performed excellent. In all cases the perforations were clearly visible when held up to the light (backlight).

### Example 4

This example illustrates the effect of the type and the thickness of the protective laminate or biaxially stretched polyethylene terephthalate film laminated after microperforation of a PETG security laminate precursor.

### Preparation of Security Lamin Precursor SLP-2

A security laminate precursor SLP-2 in an ID-1 format as defined in ISO 7810 was produced by laminating together three opaque 200 μm PETG films with 6% by weight titanium dioxide was also supplied by FOLIENWERK WOLFEN GMBH using a GMP Excellam™ 655Q hot roll laminator. The GMP Excellam™ 65Q hot roll laminator was set at a lamination temperature of 160° C., a distance of 1 mm between the rolls, a speed setting of 1 and inserting the laminates protected between a silicon based paper (Codor-carrier N° 57001310 from CODOR) to prevent sticking to laminator rolls.

### Lamination and Evaluation of Outermost Lamellae

In the security laminate precursor SLP-2, 13 microperforations were drilled in a straight line with a drill of 0.2 mm at a distance of 2 mm from each other. The obtained visible microperforations had a diameter of 150 μm (measured with a Dino microscope, 200×). The perforated security laminate precursors were then laminated on both sides with a number of the same protective laminates and biaxially stretched polyethylene terephthalate films of EXAMPLE 3 according to Table 11. The protective laminate 63 μm PET-C/SUB-3/35 μm PETG was prepared by laminating the 63 μm PET-C film with subbing layer 3 against a 35 μm PET-C film.

The same folding test as in EXAMPLE 2 with an Elcometer™ 1500 mandrel having a diameter of 2 mm was used these security laminates.

TABLE 11

| Protective laminate | Relief touch | Number of torn |
|---|---|---|
| or PET-C film | detectable? | perforations |
| None | Yes | 13 |
| 63 μm PET-C/SUB-3/35 μm PETG | No | 0 |
| 63 μm PET-C/SUB-3 | No | 0 |
| 100 μm PET-C/SUB-4 | No | 0 |
| 63 μm PET-C/SUB-3/Platilon ID5051 | No | 0 |
| 100 μm PET-C/SUB-4/Platilon ID5051 | No | 0 |
| 63 μm PET-C/SUB-3/Scapa G160 | No | 0 |
| 100 μm PET-C/SUB-4/Scapa G160 | No | 0 |

Table 11 shows that PET-C films can be used with or without polyurethane adhesives to successfully prevent torn perforations. In all cases the perforations were clearly visible when held up to the light (backlight).

### Example 5

This example illustrates that the perforations can be filled up with a component (e.g. luminescent, phosphorescent or fluorescent dyes and pigments, infrared dyes and pigments, magnetic particles and the like) to provide an additional security feature.

### Preparation of Security Laminate

On one side (“recto side”) of a security laminate precursor SLP-2 drilled with 13 microperforations in a straight line, a UV-waterless offset phosphor ink (UV security ink from SICPA) was applied to the microperforations area. The excess of ink was wiped off. The ink was cured using UV light. Then on both sides of the security laminate precursor SLP-2, a protective laminate 63 μm PET-C/SUB-3/35 μm PETG was laminated using a GMP Excellam™ 655Q hot roll laminator. The GMP Excellam™ 655Q hot roll laminator was set at a lamination temperature of 160° C., a distance of 1 mm between the rolls, a speed setting of 1 and inserting the laminates protected between a silicon based paper (Codor-carrier N° 57001310 from CODOR) to prevent sticking to laminator roils.

### Evaluation of the Security Laminate

The microperforations were no longer visible when held up to the day light (backlight) from both the recto and the verso side. When exposing the recto side with UV-light and observing the security laminate in reflection, no discrimination could be made between the microperforations and the surrounding area on the phosphorescent surface. When exposing the verso side with UV-light and observing the security laminate in reflection, the microperforations could be clearly distinguished as phosphorescent dots from the surrounding area.

The present invention may include any feature or combination of features disclosed herein either implicitly or explicitly or any generalisation thereof. In view of the foregoing description it will be evident to a person skilled in the art that various modifications may be made within the scope of the invention.

1-15. (canceled)

16. A security laminate precursor comprising a plurality of lamellae and layers, wherein at least one of the outermost lamellae is an axially stretched linear polyester film, the security laminate precursor further comprising a touch-detectable relief structure on a side of the security laminate precursor having as outermost lamella the axially stretched linear polyester film, wherein the relief structure is associated with a viewable non-surface image which is a pattern made up of micro-perforations.

17. The security laminate precursor according to claim 16, wherein the micro-perforations of the viewable non-surface image are produced with a laser.

18. The security laminate precursor according to claim 16, wherein the linear polyester film is a biaxially stretched polyethylene terephthalate film.

19. The security laminate precursor according to claim 16, wherein both outermost lamellae are linear polyester films.

20. The security laminate precursor according to claim 19, wherein both the linear polyester films are biaxially stretched polyethylene terephthalate films.

21. The security laminate precursor according to claim 16, wherein the security laminate precursor comprises a layer comprising an optionally micro-perforated DTR image.

22. The security laminate precursor according to claim 16, wherein the security laminate precursor further comprises at least one lamella selected from the group consisting of amorphous polyester lamellae, polycarbonate lamellae, polyolefin lamellae and polyvinyl chloride lamellae.

23. A security laminate comprising the security laminate precursor as defined by claim 16.

24. A security laminate comprising the security laminate precursor as defined by claim 17.

25. A security laminate comprising the security laminate precursor as defined by claim 18.

26. A security laminate comprising the security laminate precursor as defined by claim 19.

27. A security laminate comprising the security laminate precursor as defined by claim 20.

28. A security laminate comprising the security laminate precursor as defined by claim 21.

29. A security laminate comprising the security laminate precursor as defined by claim 22.

30. The security laminate according to claim 23, wherein the outermost lamellae are not perforated biaxially stretched polyethylene terephthalate films having a thickness of at least 10 μm and whereby the relief is no longer touch detectable.

31. The security laminate according to claim 24, wherein the outermost lamellae are not perforated biaxially stretched polyethylene terephthalate films having a thickness of at least 10 μm and whereby the relief is no longer touch detectable.

32. The security laminate according to claim 25, wherein the outermost lamellae are not perforated biaxially stretched polyethylene terephthalate films having a thickness of at least 10 μm and whereby the relief is no longer touch detectable.

33. The security laminate according to claim 26, wherein the outermost lamellae are not perforated biaxially stretched polyethylene terephthalate films having a thickness of at least 10 μm and whereby the relief is no longer touch detectable.

34. The security laminate according to claim 27, wherein the outermost lamellae are not perforated biaxially stretched polyethylene terephthalate films having a thickness of at least 10 μm and whereby the relief is no longer touch detectable.

35. The security laminate according to claim 28, wherein the outermost lamellae are not perforated biaxially stretched polyethylene terephthalate films having a thickness of at least 10 μm and whereby the relief is no longer touch detectable.

36. The security laminate according to claim 29, wherein the outermost lamellae are not perforated biaxially stretched polyethylene terephthalate films having a thickness of at least 10 μm and whereby the relief is no longer touch detectable.

37. A security laminate comprising a plurality of lamellae and layers, wherein at least one of the outermost lamellae of the security laminate is an axially stretched linear polyester film comprising a security laminate precursor, and wherein the security laminate precursor comprises a touch-detectable relief structure being associated with a viewable non-surface image which is a pattern made up of micro-perforations.

38. The security laminate according to claim 23, wherein the security laminate is an identity document or an identification card.

39. The security laminate according to claim 24, wherein the security laminate is an identity document or an identification card.

40. The security laminate according to claim 25, wherein the security laminate is an identity document or an identification card.

41. The security laminate according to claim 26, wherein the security laminate is an identity document or an identification card.

42. The security laminate according to claim 27, wherein the security laminate is an identity document or an identification card.

43. The security laminate according to claim 28, wherein the security laminate is an identity document or an identification card.

44. The security laminate according to claim 29, wherein the security laminate is an identity document or an identification card.

45. The security laminate according to claim 23, wherein a number or all of the microperforations in the security laminate contain at least one component selected from the group consisting of luminescent dyes, phosphorescent dyes, fluorescent dyes, luminescent pigments, phosphorescent pigments, fluorescent pigments, infrared dyes, infrared pigments and magnetic particles.

46. The security laminate according to claim 24, wherein a number or all of the microperforations in the security laminate contain at least one component selected from the group consisting of luminescent dyes, phosphorescent dyes, fluorescent dyes, luminescent pigments, phosphorescent pigments, fluorescent pigments, infrared dyes, infrared pigments and magnetic particles.

47. The security laminate according to claim 25, wherein a number or all of the microperforations in the security laminate contain at least one component selected from the group consisting of luminescent dyes, phosphorescent dyes, fluorescent dyes, luminescent pigments, phosphorescent pigments, fluorescent pigments, infrared dyes, infrared pigments and magnetic particles.

48. The security laminate according to claim 26, wherein a number or all of the microperforations in the security laminate contain at least one component selected from the group consisting of luminescent dyes, phosphorescent dyes, fluorescent dyes, luminescent pigments, phosphorescent pigments, fluorescent pigments, infrared dyes, infrared pigments and magnetic particles.

49. The security laminate according to claim 27, wherein a number or all of the microperforations in the security laminate contain at least one component selected from the group consisting of luminescent dyes, phosphorescent dyes, fluorescent dyes, luminescent pigments, phosphorescent pigments, fluorescent pigments, infrared dyes, infrared pigments and magnetic particles.

50. The security laminate according to claim 28, wherein a number or all of the microperforations in the security laminate contain at least one component selected from the group consisting of luminescent dyes, phosphorescent dyes, fluorescent dyes, luminescent pigments, phosphorescent pigments, fluorescent pigments, infrared dyes, infrared pigments and magnetic particles.

51. The security laminate according to claim 29, wherein a number or all of the microperforations in the security laminate contain at least one component selected from the group consisting of luminescent dyes, phosphorescent dyes, fluorescent dyes, luminescent pigments, phosphorescent pigments, fluorescent pigments, infrared dyes, infrared pigments and magnetic particles.

52. A process for preparing a security laminate comprising the steps of:
(a) providing a security laminate precursor comprising a plurality of lamellae and layers, wherein at least one of the outermost lamellae of the security laminate is an axially stretched linear polyester film; and
(b) irradiating the side of the security laminate precursor with the linear polyester film as outermost lamella with a laser to provide an image by microperforation thereby producing a touch detectable relief structure associated with a viewable non-surface image which is the pattern made up of microperforations.

53. The process according to claim 52, wherein a linear polyester film is laminated onto the perforated outermost lamella whereby the relief is no longer touch detectable.
